(19) United States
(12) Patent Application Publication
(10) Pub. No.: US 2010/0210460 A1
(43) Pub. Date: Aug. 19, 2010

(54) BLENDED REFUGE DEPLOYMENT VIA MANIPULATION DURING HYBRID SEED PRODUCTION

(75) Inventors: Peter D. Coaldrake, Johnston, IA (US); John L. Flexner, Landenberg, PA (US); Laura S. Higgins, Des Moines, IA (US); Stephen A. Lefko, Marietta, GA (US); Timothy M. Nowatzki, Granger, IA (US)

Correspondence Address: ALSTON & BIRD LLP;PIONEER HI-BRED INTERNATIONAL, INC., BANK OF AMERICA PLAZA, 101 SOUTH TRYON STREET, SUITE 4000, CHARLOTTE, NC, 28280-4000, US

(73) Assignees: Pioneer Hi-Bred International, Inc., Johnston, IA (US); E. I. Du Pont De Nemours and Company, Wilmington, DE (US)

(21) Appl. No.: 12/708,771

(22) Filed: Feb. 19, 2010

Related U.S. Application Data
(60) Provisional application No. 61/153,689, filed on Feb. 19, 2009.

(51) Int. Cl. A01N 25/00; A01C 1/00

(52) U.S. Cl. 504/116.1; 514/789; 47/58.1 SE

(57) ABSTRACT

Insect refuge strategies are described for the management of insect resistance development. The present invention relates generally to the control of pests that cause damage to crop plants, and in particular to corn plants, by their feeding activities directed to root damage, and more particularly to the control of such plant pests by ensuring, through the seed production process, that sufficient refuge seeds are present in a given set of seeds to reduce the rate of development of resistant pests, thereby eliminating the problems that may arise with regard to refuge compliance. In addition, the treatment of such seed with a chemical or peptide-associated pesticide prior to planting the seed is also disclosed.

### CROSS-REFERENCE TO RELATED APPLICATIONS

This application claims the benefit of U.S. Provisional Application No. 61/153,689, filed Feb. 19, 2009, which is hereby incorporated herein in its entirety by reference.

### FIELD OF THE INVENTION

The present invention relates to methods for managing insect resistance in crop plants.

### BACKGROUND OF THE INVENTION

Insects, nematodes, and related arthropods annually destroy an estimated 15% of agricultural crops in the United States and even more than that in developing countries. Yearly, these pests cause over $100 billion dollars in crop damage in the U.S. alone. In addition, competition with weeds and parasitic and saprophytic plants account for even more potential yield losses.

Some of this damage occurs in the soil when plant pathogens, insects and other such soil borne pests attack the seed after planting. In the production of corn, for example, much of the damage is caused by rootworms, insect pests that feed upon or otherwise damage the plant roots, and by cutworms, European corn borers, and other pests that feed upon or damage the above ground parts of the plant. General descriptions of the type and mechanisms of attack of pests on agricultural crops are provided by, e.g., Metcalf (1962), in Destructive and Useful Insects, 4th ed. (McGraw-Hill Book Co., NY); and Agrios (1988), in Plant Pathology, 3d ed. (Academic Press, NY).

In an ongoing seasonal battle, farmers apply billions of gallons of synthetic pesticides to combat these pests. However, synthetic pesticides pose many problems. They are expensive, costing U.S. farmers alone almost $8 billion dollars per year. They force the emergence of insecticide-resistant pests, and they can harm the environment.

Because of concern about the impact of pesticides on public health and the health of the environment, significant efforts have been made to find ways to reduce the amount of chemical pesticides that are used. Recently, much of this effort has focused on the development of transgenic crops that are engineered to express insect toxicants derived from microorganisms. For example, U.S. Pat. No. 5,877,012 to Estruch et al. discloses the cloning and expression of proteins from such organisms as Bacillus, Pseudomonas, Clavibacter and Rhizobium into plants to obtain transgenic plants with resistance to such pests as black cutworms, armyworms, several borers and other insect pests. Publication WO/EP97/07089 by Privalle et al. teaches the transformation of monocotyledons, such as corn, with a recombinant DNA sequence encoding peroxidase for the protection of the plant from feeding by corn borers, earworms and cutworms. Jansens et al. (1997) Crop Sci., 37(5): 1616-1624, reported the production of transgenic corn containing a gene encoding a crystalline protein from Bt that controlled both generations of Eastern Corn Borer (ECB). U.S. Pat. Nos. 5,625,136 and 5,859,336 to Koziel et al. reported that the transformation of corn with a gene from Bt that encoded for a δ-endotoxin provided the transgenic corn with improved resistance to ECB. A comprehensive report of field trials of transgenic corn that expresses an insecticidal protein from Bacillus thuringiensis (Bt) has been provided by Armstrong et al., in Crop Science, 35(2):550-557 (1995).

An environmentally friendly approach to controlling pests is the use of pesticidal crystal proteins derived from the soil bacterium Bacillus thuringiensis (Bt), commonly referred to as “Cry proteins” or “Cry peptides.” The Cry proteins are globular protein molecules which accumulate as protoxins in crystalline form during late stage of the sporulation of Bt. After ingestion by the pest, the crystals are solubilized to release protoxins in the alkaline midgut environment of the larvae. Protoxins (˜130 kDa) are converted into toxic fragments (˜66 kDa N terminal region) by gut proteases. Many of these proteins are quite toxic to specific target insects, but harmless to plants and other non-targeted organisms. Some Cry proteins have been recombinantly expressed in crop plants to provide pest-resistant transgenic plants. Among those, Bt-transgenic cotton and corn have been widely cultivated.

A large number of Cry proteins have been isolated, characterized and classified based on amino acid sequence homology (Crickmore et al., 1998, Microbiol. Mol. Biol. Rev., 62: 807-813). This classification scheme provides a systematic mechanism for naming and categorizing newly discovered Cry proteins. The Cry1 classification is the best known and contains the highest number of cry genes which currently totals over 130.

One biotype of Western Corn Rootworm (WCRW), which deposits its eggs in soybeans and possibly other crop habitats, is now capable of causing significant injury to first-year corn (i.e., corn that has not systematically followed corn). This biotype is commonly called first-year corn rootworm or rotation-resistant corn rootworm. First-year corn may also be susceptible to rootworm injury when eggs remain in the soil for more than a year. In this situation, the eggs deposited in the plot remain dormant throughout the following year and then hatch the next year, when corn may again be planted in a two-year rotation cycle. Such rootworm activity is called extended diapause and is commonly associated with Northern Corn Rootworm (NCRW), especially in the northwestern region of the Corn Belt. This biotype of WCRW causes additional problems with regard to resistance management, as planting a crop that does not serve as a host to the insects does not affect the insects.

Further, most countries, including the United States, require extensive registration requirements when transgenic crops are used in order to minimize the development of resistant pests, and thereby extend the useful life of known biopesticides. One of the most common examples of a refuge is where in a given crop, 80% of the seed planted may contain a transgenic event which kills a target pest (such as WCRW), but 20% of the seed must not contain that transgenic event. The goal of such a refuge strategy is prevent the target pests from developing resistance to the particular biopesticide produced by the transgenic crop. Because those target insects that reach maturity in the 80% transgenic area will likely be resistant to the biopesticide used there, the refuge permits adult WCRW insects to develop that are not resistant to the biopesticide used in the transgenic seeds. As a result, the non-resistant insects breed with the resistant insects, and, because the resistance gene is typically recessive, eliminate much of the resistance in the next generation of insects. The problem with this refuge strategy is that in order to produce susceptible insects, some of the crop planted must be susceptible to the pest, thereby reducing yield.

As indicated above, one concern is that resistant ECB, WCRW, or other pests will emerge. One strategy for combating the development of resistance is to select a recombinant corn event which expresses high levels of the insecticidal protein such that one or a few bites of a transgenic corn plant would cause at least total cessation of feeding and subsequent death of the pest, even if the pest is heterozygotic for the resistance trait (i.e., the pest is the result of a resistant pest mating with a non-resistant pest).

Another strategy would be to combine a second ECB or WCRW specific insecticidal protein in the form of a recombinant event in the same plant or in an adjacent plant, for example, another Cry protein or alternatively another insecticidal protein such as a recombinant acyl lipid hydrolase or insecticidal variant thereof. See, e.g., WO 01/49834. Preferably, the second toxin or toxin complex would have a different mode of action than the first toxin, and preferably, if receptors were involved in the toxicity of the insect to the recombinant protein, the receptors for each of the two or more insecticidal proteins in the same plant or an adjacent plant would be different so that if a change of function of a receptor or a loss of function of a receptor developed as the cause of resistance to the particular insecticidal protein, then it should not and likely would not affect the insecticidal activity of the remaining toxin which would be shown to bind to a receptor different from the receptor causing the loss of function of one of the two insecticidal proteins cloned into a plant. Accordingly, the first one or more transgenes and the second one or more transgenes are preferably insecticidal to the same target insect and bind without competition to different binding sites in the gut membranes of the target insect.

Other examples of the control of pests by applying insecticides directly to plant seed are provided in, for example, U.S. Pat. No. 5,696,144, which discloses that ECB caused less feeding damage to corn plants grown from seed treated with a 1-arylpyrazole compound at a rate of 500 g per quintal of seed than control plants grown from untreated seed. In addition, U.S. Pat. No. 5,876,739 to Turnblad et al. (and its parent, U.S. Pat. No. 5,849,320) disclose a method for controlling soil-borne insects which involves treating seeds with a coating containing one or more polymeric binders and an insecticide. This reference provides a list of insecticides that it identifies as candidates for use in this coating and also names a number of potential target insects.

Although recent developments in genetic engineering of plants have improved the ability to protect plants from pests without using chemical pesticides, and while such techniques such as the treatment of seeds with pesticides have reduced the harmful effects of pesticides on the environment, numerous problems remain that limit the successful application of these methods under actual field conditions.

Insect resistance management (IRM) is the term used to describe practices aimed at reducing the potential for insect pests to become resistant to a pesticide. Maintenance of Bt IRM is of great importance because of the threat insect resistance poses to the future use of Bt plant-incorporated protectants and Bt technology as a whole. Specific IRM strategies, such as the high dose/structured refuge strategy, mitigate insect resistance to specific Bt proteins produced in corn, cotton, and potatoes. However, such strategies result in portions of crops being left susceptible to one or more pests in order to ensure that non-resistant insects develop and become available to mate with any resistant pests produced in protected crops. Accordingly, from a farmer/producer's perspective, it is highly desirable to have as small a refuge as possible and yet still manage insect resistance, in order that the greatest yield be obtained while still maintaining the efficacy of the pest control method used, whether Bt, chemical, some other method, or combinations thereof.

The most frequently-used current IRM strategy is a high dose and the planting of a refuge (a portion of the total acreage using non-Bt seed), as it is commonly-believed that this will delay the development of insect resistance to Bt crops by maintaining insect susceptibility. High dose was defined by an expert panel convened by the US Environmental Protection Agency as plant production of a toxin concentration 25× that which is required to kill 99% of a susceptible population. The theoretical basis of the high dose/refuge strategy for delaying resistance hinges on the assumption that the frequency and recessiveness of insect resistance is inversely proportional to pest susceptibility; resistance will be rare and recessive only when pests are very susceptible to the toxin, and conversely resistance will be more frequent and less recessive when pests are not very susceptible. Furthermore, the high dose/refuge strategy assumes that resistance to Bt is recessive and is conferred by a single locus with two alleles resulting in three genotypes: susceptible homozygotes (SS), heterozygotes (RS), and resistant homozygotes (RR). It also assumes that there will be a low initial resistance allele frequency and that there will be extensive random mating between resistant and susceptible adults. Under ideal circumstances, only rare RR individuals will survive a high dose produced by the Bt crop. Both SS and RS individuals will be susceptible to the Bt toxin. A structured refuge is a non-Bt portion of a grower's field or set of fields that provides for the production of susceptible (SS) insects that may randomly mate with rare resistant (RR) insects surviving the Bt crop to produce susceptible RS heterozygotes that will be killed by the Bt crop. This will remove resistant (R) alleles from the insect populations and delay the evolution of resistance.

The high dose/refuge strategy is the most recognized strategy for IRM, and is the historical basis for regulatory agencies. Non-high dose strategies are currently used in an IRM strategy by increasing refuge size. The refuge is increased because lack of a high dose could allow partially resistant (i.e., heterozygous insects with one resistance allele) to survive, thus increasing the frequency of resistance genes in an insect population. For this reason, numerous IRM researchers and expert groups have concurred that in general non-high dose Bt expression presents a substantial resistance risk relative to high dose expression (Roush 1994, Gould 1998, Onstad & Gould 1998, SAP 1998, ILSI 1998, UCS 1998, SAP 2001). However, such non-high dose strategies are typically unacceptable for the farmer, as the greater refuge size results in further loss of yield.

Currently, the size, placement, and management of the refuge is often considered critical to the success of the high dose/structured refuge strategy to mitigate insect resistance to the Bt proteins produced in corn, cotton, and potatoes. Structured refuges are generally required to include all suitable non-Bt host plants for a targeted pest that are planted and managed by people. These refuges could be planted to offer refuges at the same time when the Bt crops are available to the pests or at times when the Bt crops are not available. The problems with these types of refuges include ensuring random mating between resistant and susceptible insects, different management practices between refuge and Bt plots that lead to asynchrony between refuge and Bt crops and resulting pest populations, and compliance (or lack thereof) with the separate refuge requirements by individual farmers. Because of the decrease in yield in refuge planting areas, some farmers choose to eschew the refuge requirements, and others do not follow the size and/or placement requirements. These issues result in either no refuge or less effective refuge, and a corresponding increase in the development of resistance pests.

Accordingly, there remains a need for methods for managing pest resistance in a plot of pest resistant crop plants. It would be useful to provide an improved method for the protection of plants, especially corn plants, from feeding damage by pests. It would be particularly useful if such a method would reduce the required application rate of conventional chemical pesticides, and also if it would limit the number of separate field operations that were required for crop planting and cultivation. In addition, it would be useful to have a method of deploying a transgenic refuge that eliminates the above-described problems with regard to compliance that dilute or remove the efficacy of many resistance management strategies.

### Plant Breeding Techniques

The goal of plant breeding is to combine, in a single variety or hybrid, various desirable traits. For field crops, these traits may include resistance to diseases and insects, tolerance to heat and drought, reducing the time to crop maturity, greater yield, and better agronomic quality. With mechanical harvesting of many crops, uniformity of plant characteristics such as germination, stand establishment, growth rate, maturity, and plant and ear height is important. Traditional plant breeding is an important tool in developing new and improved commercial crops.

Field crops are bred through techniques that take advantage of the plant's method of pollination. A plant is self-pollinated if pollen from one flower is transferred to the same or another flower of the same plant. A plant is sib pollinated when individuals within the same family or line are used for pollination. A plant is cross-pollinated if the pollen comes from a flower on a different plant from a different family or line. The term “cross pollination” and “out-cross” as used herein do not include self pollination or sib pollination.

Plants that have been self-pollinated and selected for type for many generations become homozygous at almost all gene loci and produce a uniform population of true breeding progeny. A cross between two different homozygous lines produces a uniform population of hybrid plants that may be heterozygous for many gene loci. A cross of two plants each heterozygous at a number of gene loci will produce a population of heterogeneous plants that differ genetically and will not be uniform.

Maize can be bred by both self-pollination and cross-pollination techniques. Maize has separate male and female flowers on the same plant, located on the tassel and the ear, respectively. Natural pollination occurs in maize when wind blows pollen from the tassels to the silks that protrude from the tops of the ears.

The development of a hybrid maize variety in a maize plant breeding program involves three steps: (1) the selection of plants from various germplasm pools for initial breeding crosses; (2) the selfing of the selected plants from the breeding crosses for several generations to produce a series of inbred lines, which, individually breed true and are highly uniform; and (3) crossing a selected inbred line with an unrelated inbred line to produce the hybrid progeny (F1). After a sufficient amount of inbreeding successive generations will merely serve to increase seed of the developed inbred. Preferably, an inbred line should comprise homozygous alleles at about 95% or more of its loci.

During the inbreeding process in maize, the vigor of the lines decreases. Vigor is restored when two different inbred lines are crossed to produce the hybrid progeny (F1). An important consequence of the homozygosity and homogeneity of the inbred lines is that the hybrid between a defined pair of inbreds may be reproduced indefinitely as long as the homogeneity of the inbred parents is maintained. Once the inbreds that create a superior hybrid have been identified, a continual supply of the hybrid seed can be produced using these inbred parents and the hybrid corn plants can then be generated from this hybrid seed supply.

A single cross hybrid is produced when two inbred lines are crossed to produce the F1 progeny. A double cross hybrid is produced from four inbred lines crossed in pairs (A×B and C×D) and then the two F1 hybrids are crossed again (A×B)×(C×D). A three-way cross hybrid is produced from three inbred lines where two of the inbred lines are crossed (A×B) and then the resulting F1 hybrid is crossed with the third inbred (A×B)×C. In each case, pericarp tissue from the female parent will be a part of and protect the hybrid seed.

Large scale commercial maize hybrid seed production, as it is practiced today, requires the use of some form of male sterility system which controls or inactivates male fertility. A reliable method of controlling male fertility in plants also offers the opportunity for improved plant breeding. This is especially true for development of maize hybrids, which relies upon some sort of male sterility system. There are several ways in which a maize plant can be manipulated so that it is male sterile. These include use of manual or mechanical emasculation (or detasseling), cytoplasmic genetic male sterility, nuclear genetic male sterility, gametocides and the like.

Hybrid maize seed is often produced by a male sterility system incorporating manual or mechanical detasseling. Alternate strips of two inbred varieties of maize are planted in a field, and the pollen-bearing tassels are removed from one of the inbreds (“female”) prior to pollen shed. Providing that there is sufficient isolation from sources of foreign maize pollen, the ears of the detasseled inbred will be fertilized only from the other inbred (“male”), and the resulting seed is therefore hybrid and will form hybrid plants.

The laborious detasseling process can be avoided by using cytoplasmic male-sterile (CMS) inbreds. Plants of a CMS inbred are male sterile as a result of genetic factors in the cytoplasm, as opposed to the nucleus. Thus, this characteristic is inherited exclusively through the “female” parent in maize plants, since only the female gamete provides cytoplasm to the fertilized seed. CMS plants are fertilized with pollen from another inbred that is not male-sterile. Pollen from the second inbred may or may not contribute genes that make the hybrid plants male-fertile, and either option may be preferred depending on the intended use of the hybrid. The same hybrid seed, a portion produced from detasseled fertile maize and a portion produced using the CMS system can be blended to insure that adequate pollen loads are available for fertilization when the hybrid plants are grown. CMS systems have been successfully used since the 1950's, and the male sterility trait is routinely backcrossed into inbred lines. See Wych, p. 585-586, 1998.

There are several methods of conferring genetic male sterility available, such as multiple mutant genes at separate locations within the genome that confer male sterility, as disclosed in U.S. Pat. Nos. 4,654,465 and 4,727,219 to Brar et al. and chromosomal translocations as described by Patterson in U.S. Pat. Nos. 3,861,709 and 3,710,511. These and all patents referred to are incorporated by reference. In addition to these methods, Albertsen et al., of Pioneer Hi-Bred, U.S. Pat. No. 5,432,068, describe a system of nuclear male sterility which includes: identifying a gene which is critical to male fertility; silencing this native gene which is critical to male fertility; removing the native promoter from the essential male fertility gene and replacing it with an inducible promoter; inserting this genetically engineered gene back into the plant; and thus creating a plant that is male sterile because the inducible promoter is not “on” resulting in the male fertility gene not being transcribed. Fertility is restored by inducing, or turning “on”, the promoter, which in turn allows the gene that confers male fertility to be transcribed.

These and the other methods of conferring genetic male sterility each possess their own benefits and drawbacks. Some other methods use a variety of approaches such as delivering into the plant a gene encoding a cytotoxic substance associated with a male tissue specific promoter or an antisense system in which a gene critical to fertility is identified and an antisense to that gene is inserted in the plant (see Fabinjanski, et al. EPO 89/3010153.8 Publication No. 329,308 and PCT Application PCT/CA90/00037 published as WO 90/08828).

Another system useful in controlling male sterility makes use of gametocides. Gametocides are not a genetic system, but rather a topical application of chemicals. These chemicals affect cells that are critical to male fertility. The application of these chemicals affects fertility in the plants only for the growing season in which the gametocide is applied (see Carlson, Glenn R., U.S. Pat. No. 4,936,904). Application of the gametocide, timing of the application and genotype specificity often limit the usefulness of the approach and it is not appropriate in all situations.

Currently, insect resistance management issues are not generally contemplated in the hybrid production process, apart from general considerations as to which hybrid seeds posses various insect resistance traits, or are treated with particular seed treatments that may confer insect resistance. Accordingly, there is a potential for increased efficiency by developing ways to implement insect resistance management strategies for appropriate insect control traits or trait combinations into the hybrid seed production process.

### SUMMARY OF THE INVENTION

The invention therefore relates to methods of reducing the development of resistant pests.

The invention further relates to a method of reducing the development of resistant pests comprising manipulating the production of seed in order to have appropriate amounts of one or more seed types in a given production source to meet insect resistance management requirements. The method may include planting parental lines in ratios sufficient to produce a desired ratio of seeds of pest resistant plants to seeds of non-pest resistant plants. Alternatively, it may include planting parental lines in ratios sufficient to produce a desired ratio of a first type of seeds of pest resistant plants with pest resistance based on a first mode of pesticidal action to a second type of seeds of pest resistant plants with pest resistance based on a second mode of pesticidal action.

The invention further relates to methods of reducing the development of resistant pests comprising producing a first and second seed type, and treating one or more of the first and second seed types with a seed treatment.

Additionally, the invention relates to a method of reducing the development of resistant pests comprising combining, during the packaging process, a plurality of seed types in to a package, wherein the combined seeds are resistant to a target pest through at least one mode of pesticidal action, and such that the combined seeds may be planted in a plot either without a separate structured refuge or with a reduced refuge.

Additional detail regarding the disclosed invention will be provided in the following description.

### DETAILED DESCRIPTION

In the description that follows, a number of terms are used extensively. The following definitions are provided to facilitate understanding of the invention.

The article “a” and “an” are used herein to refer to one or more than one (i.e., to at least one) of the grammatical object of the article. By way of example, “an element” means one or more element. As used herein, the term “comprising” means “including but not limited to.”

A “plot” is intended to mean an area where crops are planted of whatever size. As used herein, the term “transgenic pest resistant crop plant” means a plant or progeny thereof (including seeds) derived from a transformed plant cell or protoplast, wherein the plant DNA contains an introduced heterologous DNA molecule, not originally present in a native, non-transgenic plant of the same strain, that confers resistance to one or more corn rootworms. The term refers to the original transformant and progeny of the transformant that include the heterologous DNA. The term also refers to progeny produced by a sexual outcross between the transformant and another variety that includes the heterologous DNA. It is also to be understood that two different transgenic plants can also be mated to produce offspring that contain two or more independently segregating, added, heterologous genes. Selfing of appropriate progeny can produce plants that are homozygous for both added, heterologous genes. Back-crossing to a parental plant and out-crossing with a non-transgenic plant are also contemplated, as is vegetative propagation. Descriptions of other breeding methods that are commonly used for different traits and crop plants can be found in one of several references, e.g., Fehr (1987), in Breeding Methods for Cultivar Development, ed. J. Wilcox (American Society of Agronomy, Madison, Wis.). Breeding methods can also be used to transfer any natural resistance genes into crop plants.

As used herein, the term “corn” means Zea mays or maize and includes all plant varieties that can be bred with corn, including wild maize species. In one embodiment, the disclosed methods are useful for managing resistance in a plot of pest resistant corn, where corn is systematically followed by corn (i.e., continuous corn). In another embodiment, the methods are useful for managing resistance in a plot of first-year pest resistant corn, that is, where corn is followed by another crop (e.g., soybeans), in a two-year rotation cycle. Other rotation cycles are also contemplated in the context of the invention, for example where corn is followed by multiple years of one or more other crops, so as to prevent resistance in other extended diapause pests that may develop over time.

A crop is considered to have a “high dose” of a pesticidal agent if it has or produces at least about 25 times the concentration of pesticidal agent (such as, for example, Bt protein) necessary to kill 99% of susceptible larvae. For example, in the context of Bt crops, Bt cultivars must produce a high enough toxin concentration to kill nearly all of the insects that are heterozygous for resistance, assuming, of course, that a single gene can confer resistance to the particular Bt protein or other toxin. Currently, a Bt plant-incorporated protectant is generally considered to provide a high dose if verified by at least two of the following five approaches: 1) Serial dilution bioassay with artificial diet containing lyophilized tissues of Bt plants using tissues from non-Bt plants as controls; 2) Bioassays using plant lines with expression levels approximately 25-fold lower than the commercial cultivar determined by quantitative ELISA or some more reliable technique; 3) Survey large numbers of commercial plants in the field to make sure that the cultivar is at the LD_{99.9} or higher to assure that 95% of heterozygotes would be killed (see Andow & Hutchison 1998); 4) Similar to #3 above, but would use controlled infestation with a laboratory strain of the pest that had an LD₅₀ value similar to field strains; and 5) Determine if a later larval instar of the targeted pest could be found with an LD₅₀ that was about 25-fold higher than that of the neonate larvae. If so, for single Bt crops, the later stage could be tested on the Bt crop plants to determine if 95% or more of the later stage larvae were killed.

As used herein, the terms “pesticidal activity” and “insecticidal activity” are used synonymously to refer to activity of an organism or a substance (such as, for example, a protein) that can be measured, by way of non-limiting example, via pest mortality, retardation of pest development, pest weight loss, pest repellency, and other behavioral and physical changes of a pest after feeding and exposure for an appropriate length of time. In this manner, pesticidal activity often impacts at least one measurable parameter of pest fitness. For example, the pesticide may be a polypeptide to decrease or inhibit insect feeding and/or to increase insect mortality upon ingestion of the polypeptide. Assays for assessing pesticidal activity are well known in the art. See, e.g., U.S. Pat. Nos. 6,570,005 and 6,339,144.

As used herein, the term “pesticidal gene” or “pesticidal polynucleotide” refers to a nucleotide sequence that encodes a polypeptide that exhibits pesticidal activity. As used herein, the terms “pesticidal polypeptide,” “pesticidal protein,” or “insect toxin” is intended to mean a protein having pesticidal activity.

As used herein, the term “pesticidal” is used to refer to a toxic effect against a pest (e.g., CRW), and includes activity of either, or both, an externally supplied pesticide and/or an agent that is produced by the crop plants. As used herein, the term “different mode of pesticidal action” includes the pesticidal effects of one or more resistance traits, whether introduced into the crop plants by transformation or traditional breeding methods, such as binding of a pesticidal toxin produced by the crop plants to different binding sites (i.e., different toxin receptors and/or different sites on the same toxin receptor) in the gut membranes of corn rootworms.

As used herein, the term “transgenic” includes any cell, cell line, callus, tissue, plant part, or plant, the genotype of which has been altered by the presence of heterologous nucleic acid including those transgenics initially so altered as well as those created by sexual crosses or asexual propagation from the initial transgenic. The term “transgenic” as used herein does not encompass the alteration of the genome (chromosomal or extra-chromosomal) by conventional plant breeding methods or by naturally occurring events such as random cross-fertilization, non-recombinant viral infection, non-recombinant bacterial transformation, non-recombinant transposition, or spontaneous mutation.

A “type of seed” or “seed type” is intended to mean seed of a defined type that is not genetically identical to another type of seed that is used in the methods disclosed herein. Generally, in the methods of the invention a “first type of seed” and a “second type of seed” will be seeds from the same plant species but differ in genotype. That is, the “first type of seed” will have a different genotype than the genotype of the “second type of seed”. For example, a first type of seed can comprise a transgene and a second type of seed can lack a transgene (or comprise a different transgene), but be otherwise genetically identical to the first type of seed. In embodiments of the invention in which there are more than two types of seed, each of the types of the seed will have a genotype that is different than the genotype of each of the other types of seed. Although the methods of the present invention do not depend on each of the types of seed being from the same plant species, the two or more types of seed will be of the same plant species or two or more closely related plant species, which, for example, are hosts of the same target pests or pests. Furthermore, although a type of seed will usually consist of a single genotype, certain embodiments of the invention can involve a first type of seed that is comprised of two or more genotypes. In such embodiments, each additional type of seed is comprised of one or more genotypes that are not found in the any of the other types of seed.

As used herein, the term “plant” includes reference to whole plants, plant organs (e.g., leaves, stems, roots, etc.), seeds, plant cells, plant protoplasts, plant cell tissue cultures from which plants can be regenerated, plant calli, plant clumps, and plant cells that are intact in plants or parts of plants and progeny of same. Parts of transgenic plants are to be understood within the scope of the invention to comprise, for example, plant cells, protoplasts, tissues, callus, embryos as well as flowers, pollen, ovules, seeds, branches, kernels, ears, cobs, husks, stalks, stems, fruits, leaves, roots, root tips, anthers, and the like, originating in transgenic plants or their progeny previously transformed with a DNA molecule of the invention and therefore consisting at least in part of transgenic cells, are also an object of the present invention. Grain is intended to mean the mature seed produced by commercial growers for purposes other than growing or reproducing the species. Progeny, variants, and mutants of the regenerated plants are also included within the scope of the invention, provided that these parts comprise the introduced polynucleotides.

As used herein, the term “plant cell” includes, without limitation, seeds, suspension cultures, embryos, meristematic regions, callus tissue, leaves, roots, shoots, gametophytes, sporophytes, pollen, and microspores. The class of plants that can be used in the methods of the invention is generally as broad as the class of higher plants amenable to transformation techniques, including both monocotyledonous and dicotyledonous plants.

As used herein, the term “creating or enhancing insect resistance” is intended to mean that the plant, which has been genetically modified in accordance with the methods of the present invention, has increased resistance to one or more insect pests relative to a plant having a similar genetic component with the exception of the genetic modification described herein. Genetically modified plants of the present invention are capable of expression of at least one insecticidal lipase and at least one Bt insecticidal protein, the combination of which protects a plant from an insect pest while impacting an insect pest of a plant. “Protects a plant from an insect pest” is intended to mean the limiting or eliminating of insect pest-related damage to a plant by, for example, inhibiting the ability of the insect pest to grow, feed, and/or reproduce or by killing the insect pest. As used herein, “impacting an insect pest of a plant” includes, but is not limited to, deterring the insect pest from feeding further on the plant, harming the insect pest by, for example, inhibiting the ability of the insect to grow, feed, and/or reproduce, or killing the insect pest.

As used herein, the term “insecticidal lipase” is used in its broadest sense and includes, but is not limited to, any member of the family of lipid acyl hydrolases that has toxic or inhibitory effects on insects. Also, the term “Bt insecticidal protein” is used in its broadest sense and includes, but is not limited to, any member of the family of Bacillus thuringiensis proteins that have toxic or inhibitory effects on insects, such as Bt toxins described herein and known in the art, and includes, for example, the vegetative insecticidal proteins and the δ-endotoxins or cry toxins. Thus, as described herein, insect resistance can be conferred to an organism by introducing a nucleotide sequence encoding an insecticidal lipase with a sequence encoding a Bt insecticidal protein or applying an insecticidal substance, which includes, but is not limited to, an insecticidal protein, to an organism (e.g., a plant or plant part thereof).

Those skilled in the art will recognize that not all compounds are equally effective against all pests. Compounds of the embodiments display activity against insect pests, which may include economically important agronomic, forest, greenhouse, nursery, ornamentals, food and fiber, public and animal health, domestic and commercial structure, household, and stored product pests. Insect pests include insects selected from the orders Coleoptera, Diptera, Hymenoptera, Lepidoptera, Mallophaga, Homoptera, Hemiptera, Orthoptera, Thysanoptera, Dermaptera, Isoptera, Anoplura, Siphonaptera, Trichoptera, etc., particularly Coleoptera and Lepidoptera.

The following table will assist the reader with the acronyms for the insect pests. Note that the table lists the most common pests that are the target of transgenic pest resistance strategies, but the invention is not limited to only these pests.

TABLE 1
Insect Pests

| Acronym | Common Name | Scientific Name | Crop |
|---|---|---|---|
| BCW | Black Cutworm | Agrotis ipsilon (Hufhagel) | corn |
| CBW | Cotton Bollworm | Helicoverpa zea (Boddie) | cotton |
| CEW | Corn Earworm | Helicoverpa zea (Boddie) | corn |
| CPB | Colorado Potato Beetle | Leptinotarsa decemlineata (Say) | potato |
| CSB | Common Stalk Borer | Papaipema nebris (Guenee) | corn |
| ECB | European Corn Borer | Ostrinia nubilalis (Huebner) | corn |
| FAW | Fall Armyworm | Spodoptera frugiperda (J E Smith) | corn |
| PBW | Pink Bollworm | Pectinophora gossypiella (Saunders) | cotton |
| SCSB | Southern Corn Stalk Borer | Diatraea crambidoides (Grote) | corn |
| SWCB | Southwestern Corn Borer | Diatraea grandiosella (Dyar) | corn |
| TBW | Tobacco Budworm | Heliothis virescens (Fabricius) | cotton |
| CRW | Corn Root worm | Diabrotica spp. | corn |
| MCRW | Mexican Corn Rootworm | Diabrotica virgifera zeae | corn |
| | | (Krysan & Smith) | |
| NCRW | Northern Corn Rootworm | Diabrotica barberi (Smith & | corn |
| | | Lawrence) | |
| SCRW | Southern Corn Rootworm | Diabrotica undecimpunctata howardi | corn |
| | | (Barber) | |
| WCRW | Western Corn Rootworm | Diabrotica virgifera virgifera | corn |
| | | (LeConte) | |

### Coleoptera

Of interest are larvae and adults of the order Coleoptera including weevils from the families Anthribidae, Bruchidae, and Curculionidae (including, but not limited to: Anthonomus grandis Boheman (boll weevil); Lissorhoptrus oryzophilus Kuschel (rice water weevil); Sitophilus granarius Linnaeus (granary weevil); S. oryzae Linnaeus (rice weevil); Hypera punctata Fabricius (clover leaf weevil); Cylindrocopturus adspersus LeConte (sunflower stem weevil); Smicronyx fulvus LeConte (red sunflower seed weevil); S. sordidus LeConte (gray sunflower seed weevil); Sphenophorus maidis Chittenden (maize billbug)); flea beetles, cucumber beetles, rootworms, leaf beetles, potato beetles, and leafminers in the family Chrysomelidae (including, but not limited to: Leptinotarsa decemlineata Say (Colorado potato beetle); Diabrotica virgifera virgifera LeConte (western corn rootworm); D. barberi Smith & Lawrence (northern corn rootworm); D. undecimpunctata howardi Barber (southern corn rootworm); Chaetocnema pulicaria Melsheimer (corn flea beetle); Phyllotreta cruciferae Goeze (corn flea beetle); Colaspis brunnea Fabricius (grape colaspis); Oulema melanopus Linnaeus (cereal leaf beetle); Zygogramma exclamationis Fabricius (sunflower beetle)); beetles from the family Coccinellidae (including, but not limited to: Epilachna varivestis Mulsant (Mexican bean beetle)); chafers and other beetles from the family Scarabaeidae (including, but not limited to: Popillia japonica Newman (Japanese beetle); Cyclocephala borealis Arrow (northern masked chafer, white grub); C. immaculata Olivier (southern masked chafer, white grub); Rhizotrogus majalis Razoumowsky (European chafer); Phyllophaga crinita Burmeister (white grub); Ligyrus gibbosus De Geer (carrot beetle)); carpet beetles from the family Dermestidae; wireworms from the family Elateridae, Eleodes spp., Melanotus spp.; Conoderus spp.; Limonius spp.; Agriotes spp.; Ctenicera spp.; Aeolus spp.; bark beetles from the family Scolytidae and beetles from the family Tenebrionidae.

### Diptera

Adults and immatures of the order Diptera are of interest, including leafminers Agromyza parvicornis Loew (corn blotch leafminer); midges (including, but not limited to: Contarinia sorghicola Coquillett (sorghum midge); Mayetiola destructor Say (Hessian fly); Sitodiplosis mosellana Géhin (wheat midge); Neolasioptera murtfeldtiana Felt, (sunflower seed midge)); fruit flies (Tephritidae), Oscinella frit Linnaeus (frit flies); maggots (including, but not limited to: Delia platura Meigen (seedcorn maggot); D. coarctata Fallen (wheat bulb fly); and other Delia spp., Meromyza americana Fitch (wheat stem maggot); Musca domestica Linnaeus (house flies); Fannia canicularis Linnaeus, F. femoralis Stein (lesser house flies); Stomoxys calcitrans Linnaeus (stable flies)); face flies, horn flies, blow flies, Chrysomya spp.; Phormia spp.; and other muscoid fly pests, horse flies Tabanus spp.; bot flies Gastrophilus spp.; Oestrus spp.; cattle grubs Hypoderma spp.; deer flies Chrysops spp.; Melophagus ovinus Linnaeus (keds); and other Brachycera, mosquitoes Aedes spp.; Anopheles spp.; Culex spp.; black flies Prosimulium spp.; Simulium spp.; biting midges, sand flies, sciarids, and other Nematocera.

### Hymenoptera

Insect pests of the order Hymenoptera are also of interest, including sawflies such as Cephus cinctus Norton (wheat stem sawfly); ants (including, but not limited to: Camponotus ferrugineus Fabricius (red carpenter ant); C. pennsylvanicus De Geer (black carpenter ant); Monomorium pharaonis Linnaeus (Pharaoh ant); Wasmannia auropunctata Roger (little fire ant); Solenopsis geminata Fabricius (fire ant); S. molesta Say (thief ant); S. invicta Buren (red imported fire ant); Iridomyrmex humilis Mayr (Argentine ant); Paratrechina longicornis Latreille (crazy ant); Tetramorium caespitum Linnaeus (pavement ant); Lasius alienus Förster (cornfield ant); Tapinoma sessile Say (odorous house ant)); bees (including carpenter bees), hornets, yellow jackets and wasps.

### Lepidoptera

Larvae of the order Lepidoptera include, but are not limited to, armyworms, cutworms, loopers, and heliothines in the family Noctuidae, Spodoptera frugiperda J E Smith (fall armyworm); S. exigua Hübner (beet armyworm); S. litura Fabricius (tobacco cutworm, cluster caterpillar); Mamestra configurata Walker (bertha armyworm); M. brassicae Linnaeus (cabbage moth); Agrotis ipsilon Hufnagel (black cutworm); A. orthogonia Morrison (western cutworm); A. subterranea Fabricius (granulate cutworm); Alabama argillacea Hübner (cotton leaf worm); Trichoplusia ni Hübner (cabbage looper); Pseudoplusia includens Walker (soybean looper); Anticarsia gemmatalis Hübner (velvetbean caterpillar); Hypena scabs Fabricius (green cloverworm); Heliothis virescens Fabricius (tobacco budworm); Pseudaletia unipuncta Haworth (armyworm); Athetis mindara Barnes and Mcdunnough (rough skinned cutworm); Euxoa messoria Harris (darksided cutworm); Earias insulana Boisduval (spiny bollworm); E. vittella Fabricius (spotted bollworm); Helicoverpa armigera Hübner (American bollworm); H. zea Boddie (corn earworm or cotton bollworm); Melanchra picta Harris (zebra caterpillar); Egira (Xylomyges) curialis Grote (citrus cutworm); borers, casebearers, webworms, coneworms, and skeletonizers from the family Pyralidae, Ostrinia nubilalis Hübner (European corn borer); Amyelois transitella Walker (naval orangeworm); Anagasta kuehniella Zeller (Mediterranean flour moth); Cadra cautella Walker (almond moth); Chilo suppressalis Walker (rice stem borer); C. partellus, (sorghum borer); Corcyra cephalonica Stainton (rice moth); Crambus caliginosellus Clemens (corn root webworm); C. teterrellus Zincken (bluegrass webworm); Cnaphalocrocis medinalis Guenée (rice leaf roller); Desmia funeralis Hübner (grape leaffolder); Diaphania hyalinata Linnaeus (melon worm); D. nitidalis Stoll (pickleworm); Diatraea grandiosella Dyar (southwestern corn borer), D. saccharalis Fabricius (surgarcane borer); Eoreuma loftini Dyar (Mexican rice borer); Ephestia elutella Hübner (tobacco (cacao) moth); Galleria mellonella Linnaeus (greater wax moth); Herpetogramma licarsisalis Walker (sod webworm); Homoeosoma electellum Hulst (sunflower moth); Elasmopalpus lignosellus Zeller (lesser cornstalk borer); Achroia grisella Fabricius (lesser wax moth); Loxostege sticticalis Linnaeus (beet webworm); Orthaga thyrisalis Walker (tea tree web moth); Maruca testulalis Geyer (bean pod borer); Plodia interpunctella Hübner (Indian meal moth); Udea rubigalis Guenée (celery leaftier); and leafrollers, budworms, seed worms, and fruit worms in the family Tortricidae, Acleris gloverana Walsingham (Western blackheaded budworm); A. variana Fernald (Eastern blackheaded budworm); Archips argyrospila Walker (fruit tree leaf roller); A. rosana Linnaeus (European leaf roller); and other Archips species, Adoxophyes orana Fischer von Rösslerstamm (summer fruit tortrix moth); Cochylis hospes Walsingham (banded sunflower moth); Cydia latiferreana Walsingham (filbertworm); C. pomonella Linnaeus (coding moth); Platynota flavedana Clemens (variegated leafroller); P. stultana Walsingham (omnivorous leafroller); Lobesia botrana Denis & Schiffermüller (European grape vine moth); Spilonota ocellana Denis & Schiffermüller (eyespotted bud moth); Endopiza viteana Clemens (grape berry moth); Eupoecilia ambiguella Hübner (vine moth); Bonagota salubricola Meyrick (Brazilian apple leafroller); Grapholita molesta Busck (oriental fruit moth); Suleima helianthana Riley (sunflower bud moth); Argyrotaenia spp.; Choristoneura spp.

Selected other agronomic pests in the order Lepidoptera include, but are not limited to, Alsophila pometaria Harris (fall cankerworm); Anarsia lineatella Zeller (peach twig borer); Anisota senatoria J. E. Smith (orange striped oakworm); Antheraea pernyi Guérin-Meneville (Chinese Oak Silkmoth); Bombyx mori Linnaeus (Silkworm); Bucculatrix thurberiella Busck (cotton leaf perforator); Colias eurytheme Boisduval (alfalfa caterpillar); Datana integerrima Grote & Robinson (walnut caterpillar); Dendrolimus sibiricus Tschetwerikov (Siberian silk moth), Ennomos subsignaria Hübner (elm spanworm); Erannis tiliaria Harris (linden looper); Euproctis chrysorrhoea Linnaeus (browntail moth); Harrisina americana Guérin-Meneville (grapeleaf skeletonizer); Hemileuca oliviae Cockrell (range caterpillar); Hyphantria cunea Drury (fall webworm); Keiferia lycopersicella Walsingham (tomato pinworm); Lambdina fiscellaria fiscellaria Hulst (Eastern hemlock looper); L. fiscellaria lugubrosa Hulst (Western hemlock looper); Leucoma salicis Linnaeus (satin moth); Lymantria dispar Linnaeus (gypsy moth); Manduca quinquemaculata Haworth (five spotted hawk moth, tomato hornworm); M. sexta Haworth (tomato hornworm, tobacco hornworm); Operophtera brumata Linnaeus (winter moth); Paleacrita vernata Peck (spring cankerworm); Papilio cresphontes Cramer (giant swallowtail, orange dog); Phryganidia californica Packard (California oakworm); Phyllocnistis citrella Stainton (citrus leafminer); Phyllonorycter blancardella Fabricius (spotted tentiform leafminer); Pieris brassicae Linnaeus (large white butterfly); P. rapae Linnaeus (small white butterfly); P. napi Linnaeus (green veined white butterfly); Platyptilia carduidactyla Riley (artichoke plume moth); Plutella xylostella Linnaeus (diamondback moth); Pectinophora gossypiella Saunders (pink bollworm); Pontia protodice Boisduval & Leconte (Southern cabbageworm); Sabulodes aegrotata Guenée (omnivorous looper); Schizura concinna J. E. Smith (red humped caterpillar); Sitotroga cerealella Olivier (Angoumois grain moth); Thaumetopoea pityocampa Schiffermuller (pine processionary caterpillar); Tineola bisselliella Hummel (webbing clothesmoth); Tuta absoluta Meyrick (tomato leafminer); Yponomeuta padella Linnaeus (ermine moth); Heliothis subflexa Guenée; Malacosoma spp. and Orgyia spp.

### Mallophaga

Insect pests of the order Mallophaga are also of interest, and include Pediculus humanus capitis De Geer (head louse); P. humanus humanus Linnaeus (body louse); Menacanthus stramineus Nitzsch (chicken body louse); Trichodectes canis De Geer (dog biting louse); Goniocotes gallinae De Geer (fluff louse); Bovicola ovis Schrank (sheep body louse); Haematopinus eurysternus Nitzsch (short-nosed cattle louse); Linognathus vituli Linnaeus (long-nosed cattle louse); and other sucking and chewing parasitic lice that attack man and animals.

### Homoptera & Hemiptera

Included as insects of interest are adults and nymphs of the orders Hemiptera and Homoptera such as, but not limited to, adelgids from the family Adelgidae, plant bugs from the family Miridae, cicadas from the family Cicadidae, leafhoppers, Empoasca spp.; from the family Cicadellidae, planthoppers from the families Cixiidae, Flatidae, Fulgoroidea, Issidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Asterolecanidae, Coccidae, Dactylopiidae, Diaspididae, Eriococcidae, Ortheziidae, Phoenicococcidae and Margarodidae, lace bugs from the family Tingidae, stink bugs from the family Pentatomidae, cinch bugs, Blissus spp.; and other seed bugs from the family Lygaeidae, spittlebugs from the family Cercopidae squash bugs from the family Coreidae, and red bugs and cotton stainers from the family Pyrrhocoridae.

Agronomically important members from the order Homoptera further include, but are not limited to: Acyrthisiphon pisum Harris (pea aphid); Aphis craccivora Koch (cowpea aphid); A. fabae Scopoli (black bean aphid); A. gossypii Glover (cotton aphid, melon aphid); A. maidiradicis Forbes (corn root aphid); A. pomi De Geer (apple aphid); A. spiraecola Patch (spirea aphid); Aulacorthum solani Kaltenbach (foxglove aphid); Chaetosiphon fragaefolii Cockerell (strawberry aphid); Diuraphis noxia Kurdjumov/Mordvilko (Russian wheat aphid); Dysaphis plantaginea Paaserini (rosy apple aphid); Eriosoma lanigerum Hausmann (woolly apple aphid); Brevicoryne brassicae Linnaeus (cabbage aphid); Hyalopterus pruni Geoffroy (mealy plum aphid); Lipaphis erysimi Kaltenbach (turnip aphid); Metopolophium dirrhodum Walker (cereal aphid); Macrosiphum euphorbiae Thomas (potato aphid); Myzus persicae Sulzer (peach-potato aphid, green peach aphid); Nasonovia ribisnigri Mosley (lettuce aphid); Pemphigus spp. (root aphids and gall aphids); Rhopalosiphum maidis Fitch (corn leaf aphid); R. padi Linnaeus (bird cherry-oat aphid); Schizaphis graminum Rondani (greenbug); Sipha flava Forbes (yellow sugarcane aphid); Sitobion avenae Fabricius (English grain aphid); Therioaphis maculata Buckton (spotted alfalfa aphid); Toxoptera aurantii Boyer de Fonscolombe (black citrus aphid); and T. citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly); B. argentifolii Bellows & Perring (silverleaf whitefly); Dialeurodes citri Ashmead (citrus whitefly); Trialeurodes abutiloneus (bandedwinged whitefly) and T. vaporariorum Westwood (greenhouse whitefly); Empoasca fabae Harris (potato leafhopper); Laodelphax striatellus Fallen (smaller brown planthopper); Macrolestes quadrilineatus Forbes (aster leafhopper); Nephotettix cinticeps Uhler (green leafhopper); N. nigropictus St\dot{a}l (rice leafhopper); Nilaparvata lugens St\dot{a}l (brown planthopper); Peregrinus maidis Ashmead (corn planthopper); Sogatella furcifera Horvath (white-backed planthopper); Sogatodes orizicola Muir (rice delphacid); Typhlocyba pomaria McAtee (white apple leafhopper); Erythroneoura spp. (grape leafhoppers); Magicicada septendecim Linnaeus (periodical cicada); Icerya purchasi Maskell (cottony cushion scale); Quadraspidiotus perniciosus Comstock (San Jose scale); Planococcus citri Risso (citrus mealybug); Pseudococcus spp. (other mealybug complex); Cacopsylla pyricola Foerster (pear psylla); Trioza diospyri Ashmead (persimmon psylla).

Agronomically important species of interest from the order Hemiptera include, but are not limited to: Acrosternum hilare Say (green stink bug); Anasa tristis De Geer (squash bug); Blissus leucopterus leucopterus Say (chinch bug); Corythuca gossypii Fabricius (cotton lace bug); Cyrtopeltis modesta Distant (tomato bug); Dysdercus suturellus Herrich-Schäffer (cotton stainer); Euschistus servus Say (brown stink bug); Euschistus variolarius Palisot de Beauvois (one-spotted stink bug); Graptostethus spp. (complex of seed bugs); Leptoglossus corculus Say (leaf-footed pine seed bug); Lygus lineolaris Palisot de Beauvois (tarnished plant bug); Lygus Hesperus Knight (Western tarnished plant bug); Lygus pratensis Linnaeus (common meadow bug); Lygus rugulipennis Poppius (European tarnished plant bug); Lygocoris pabulinus Linnaeus (common green capsid); Nezara viridula Linnaeus (southern green stink bug); Oebalus pugnax Fabricius (rice stink bug); Oncopeltus fasciatus Dallas (large milkweed bug); Pseudatomoscelis seriatus Reuter (cotton fleahopper).

Furthermore, embodiments of the present invention may be effective against Hemiptera such, Calocoris norvegicus Gmelin (strawberry bug); Orthops campestris Linnaeus; Plesiocoris rugicollis Fallen (apple capsid); Cyrtopeltis modestus Distant (tomato bug); Cyrtopeltis notatus Distant (suckfly); Spanagonicus albofasciatus Reuter (whitemarked fleahopper); Diaphnocoris chlorionis Say (honeylocust plant bug); Labopidicola allii Knight (onion plant bug); Pseudatomoscelis seriatus Reuter (cotton fleahopper); Adelphocoris rapidus Say (rapid plant bug); Poecilocapsus lineatus Fabricius (four-lined plant bug); Nysius ericae Schilling (false chinch bug); Nysius raphanus Howard (false chinch bug); Nezara viridula Linnaeus (Southern green stink bug); Eurygaster spp.; Coreidae spp.; Pyrrhocoridae spp.; Tinidae spp.; Blostomatidae spp.; Reduviidae spp.; and Cimicidae spp.

### Orthoptera

Adults and immatures of the insect order Orthoptera are of interest, including grasshoppers, locusts and crickets Melanoplus sanguinipes Fabricius (migratory grasshopper); M. differentialis Thomas (differential grasshopper); M. femurrubrum De Geer, (redlegged grasshopper); Schistocerca americana Drury (American grasshopper); S. gregaria Forskal (desert locust); Locusta migratoria Linnaeus (migratory locust); Acheta domesticus Linnaeus (house cricket); and Gryllotalpa spp. (mole crickets).

### Thysanoptera

Adults and immatures of the order Thysanoptera are of interest, including Thrips tabaci Lindeman (onion thrips); Anaphothrips obscrurus Müller (grass thrips); Frankliniella fusca Hinds (tobacco thrips); Frankliniella occidentalis Pergande (western flower thrips); Neohydatothrips variabilis Beach (soybean thrips); Scirthothrips citri Moulton (citrus thrips); and other foliar feeding thrips.

### Dermaptera

Further insects of interest include adults and larvae of the order Dermaptera including earwigs from the family Forficulidae, Forficula auricularia Linnaeus (European earwig); Chelisoches morio Fabricius (black earwig).

### Trichoptera

Other insects of interest include nymphs and adults of the order Blattodea including cockroaches from the families Blattellidae and Blattidae, Blatta orientalis Linnaeus (oriental cockroach); Blattella asahinai Mizukubo (Asian cockroach); Blattella germanica Linnaeus (German cockroach); Supella longipalpa Fabricius (brownbanded cockroach); Periplaneta americana Linnaeus (American cockroach); Periplaneta brunnea Burmeister (brown cockroach); Leucophaea maderae Fabricius (Madeira cockroach).

Also included are adults and larvae of the order Acari (mites) such as Aceria tosichella Keifer (wheat curl mite); Petrobia latens Müller (brown wheat mite); spider mites and red mites in the family Tetranychidae, Panonychus ulmi Koch (European red mite); Tetranychus urticae Koch (two spotted spider mite); (T. mcdanieli McGregor (McDaniel mite); T. cinnabarinus Boisduval (carmine spider mite); T. turkestani Ugarov & Nikolski (strawberry spider mite); flat mites in the family Tenuipalpidae, Brevipalpus lewisi McGregor (citrus flat mite); rust and bud mites in the family Eriophyidae and other foliar feeding mites and mites important in human and animal health, i.e. dust mites in the family Epidermoptidae, follicle mites in the family Demodicidae, grain mites in the family Glycyphagidae, ticks in the order Ixodidae. Ixodes scapularis Say (deer tick); Ixodes holocyclus Neumann (Australian paralysis tick); Dermacentor variabilis Say (American dog tick); Amblyomma americanum Linnaeus (lone star tick); and scab and itch mites in the families Psoroptidae, Pyemotidae, and Sarcoptidae.

Insect pests of the order Thysanura are of interest, such as Lepisma saccharina Linnaeus (silverfish); Thermobia domestica Packard (firebrat).

Exemplary embodiments of the invention utilize different modes of pesticidal action to avoid development of resistance in, for example, corn rootworms. Resistance to rootworms can be introduced into the crop plant by any method known in the art. In some embodiments, the different modes of pesticidal action include toxin binding to different binding sites in the gut membranes of the corn rootworms. Transgenes in the present invention useful against rootworms include, but are not limited to, those encoding the Bt proteins Cry3A, Cry3Bb and Cry34Ab1/Cry35Ab1 protein. Other transgenes appropriate for other pests are discussed herein and are known in the art.

In some embodiments of the invention, the method of introducing resistance comprises introducing a pesticidal gene into the plant. A non-limiting example of such a gene is a gene that encodes a Bt toxin, such as a homologue of a known Cry toxin. “Bt toxin” is intended to mean the broader class of toxins found in various strains of Bt, which includes such toxins as, for example, the vegetative insecticidal proteins and the δ-endotoxins. See, e.g., Crickmore et al. (1998) Microbiol. Molec. Biol. Rev. 62:807-813; Crickmore et al. (2004) Bacillus Thuringiensis Toxin Nomenclature at lifesci.sussex.ac.uk/Home/Neil_Crickmore/Bt. The vegetative insecticidal proteins (for example, members of the VIP1, VIP2, or VIP3 classes) are secreted insecticidal proteins that undergo proteolytic processing by midgut insect fluids. They have pesticidal activity against a broad spectrum of Lepidopteran insects. See, e.g., U.S. Pat. No. 5,877,012. The Bt δ-endotoxins are toxic to larvae of a number of insect pests, including members of the Lepidoptera, Diptera, and Coleoptera orders. These insect toxins include, but are not limited to, the Cry toxins, including, for example, Cry1, Cry3, Cry5, Cry8, and Cry9.

In certain embodiments the plants produce more than one toxin, for example, via gene stacking. For example, DNA constructs in the plants of the embodiments may comprise any combination of stacked nucleotide sequences of interest in order to create plants with a desired trait. A “trait,” as used herein, refers to the phenotype derived from a particular sequence or groups of sequences. A single expression cassette may contain both a nucleotide encoding a pesticidal protein of interest, and at least one additional gene, such as a gene employed to increase or improve a desired quality of the transgenic plant. Alternatively, the additional gene(s) can be provided on multiple expression cassettes. The combinations generated can also include multiple copies of any one of the polynucleotides of interest.

For example, gene stacks in the plants of the embodiments may contain one or more polynucleotides encoding polypeptides having pesticidal and/or insecticidal activity, such as Bt toxic proteins (described in, for example, U.S. Pat. Nos. 5,188,960; 5,277,905; 5,366,892; 5,593,881; 5,625,136; 5,689,052; 5,691,308; 5,723,756; 5,747,450; 5,859,336; 6,023,013; 6,114,608; 6,180,774; 6,218,188; 6,342,660; and 7,030,295; U.S. Publication Nos. US20040199939 and US20060085870; WO2004086868; and Geiser et al. (1986) Gene 48:109) and Bt crystal proteins of the Cry34 and Cry35 classes (see, e.g., Schnepf et al. (2005) Appl. Environ. Microbiol. 71:1765-1774). Also contemplated for use in gene stacks are the vegetative insecticidal proteins (for example, members of the VIP1, VIP2, or VIP3 classes). See, e.g., U.S. Pat. Nos. 5,849,870; 5,877,012; 5,889,174; 5,990,383; 6,107,279; 6,137,033; 6,291,156; 6,429,360; U.S. Publication Nos. US20050210545; US20040133942; US20020078473.

The Bt δ-endotoxins or Cry toxins that could be used in gene stacks are well known in the art. See, e.g., U.S. Publication No. US20030177528. These toxins include Cry 1 through Cry 42, Cyt 1 and 2, Cyt-like toxin, and the binary Bt toxins. There are currently over 250 known species of Bt δ-endotoxins with a wide range of specificities and toxicities. For an expansive list see Crickmore et al. (1998) Microbiol. Mol. Biol. Rev. 62:807-813, and for regular updates via the World Wide Web, see biols.susx.ac.uk/Home/Neil_Crickmore/Bt/index. The criteria for inclusion in this list is that the proteins have significant sequence similarity to one or more toxins within the nomenclature or be a Bacillus thuringiensis parasporal inclusion protein that exhibits pesticidal activity, or that it have some experimentally verifiable toxic effect to a target organism. In the case of binary Bt toxins, those skilled in the art recognize that two Bt toxins must be co-expressed to induce Bt insecticidal activity.

Specific, non-limiting examples of Bt Cry toxins of interest include the group consisting of Cry 1 (such as Cry1A, Cry1A(a), Cry1A(b), Cry1A(c), Cry1C, Cry1D, Cry1E, Cry1F), Cry 2 (such as Cry2A), Cry 3 (such as Cry3Bb), Cry 5, Cry 8 (see GenBank Accession Nos. CAD57542, CAD57543, see also U.S. patent application Ser. No. 10/746,914), Cry 9 (such as Cry9C) and Cry34/35, as well as functional fragments, chimeric modifications, or other variants thereof.

Stacked genes in plants of the embodiments may also encode polypeptides having insecticidal activity other than Bt toxic proteins, such as lectins (Van Damme et al. (1994) Plant Mol. Biol. 24:825, pentin (described in U.S. Pat. No. 5,981,722), lipases (lipid acyl hydrolases, see, e.g., those disclosed in U.S. Pat. Nos. 6,657,046 and 5,743,477; see also WO2006131750A2), cholesterol oxidases from Streptomyces, and pesticidal proteins derived from Xenorhabdus and Photorhabdus bacteria species, Bacillus laterosporus species, and Bacillus sphaericus species, and the like. Also contemplated is the use of chimeric (hybrid) toxins (see, e.g., Bosch et al. (1994) Bio/Technology 12:915-918).

Such transformants can contain transgenes that are derived from the same class of toxin (e.g., more than one δ-endotoxin, more than one pesticidal lipase, more than one binary toxin, and the like), or the transgenes can be derived from different classes of toxins (e.g., a δ-endotoxin in combination with a pesticidal lipase or a binary toxin). For example, a plant having the ability to express an insecticidal δ-endotoxin derived from Bt (such as Cry1F), also has the ability to express at least one other δ-endotoxin that is different from the Cry1 F protein, such as, for example, a Cry1A(b) protein. Similarly, a plant having the ability to express an insecticidal δ-endotoxin derived from Bt (such as Cry1F), also has the ability to express a pesticidal lipase, such as, for example, a lipid acyl hydrolase.

In practice, certain stacked combinations of the various Bt and other genes described previously are best suited for certain pests, based on the nature of the pesticidal action and the susceptibility of certain pests to certain toxins. For example, some transgenic combinations are well-suited for use against various types of corn rootworm (CRW), including WCRW, northern corn rootworm (NCRW), and Mexican corn rootworm (MCRW). These combinations include at least Cry34/35 and Cry3A; and Cry34/35 and Cry3B. Other combinations are also known for other pests. For example, combinations well-suited for use against ECB and/or southwestern corn borer (SWCB) include at least Cry1Ab and Cry1F, Cry1Ab and Cry2, Cry1Ab and Cry9, Cry1Ab and Cry2/Vip3A stack, Cry1Ab and Cry1 FNip3A stack, Cry1 F and Cry2, Cry1 F and Cry9, as well as Cry1F and Cry2/Vip3A stack. Combinations appropriate for use against corn earworm (CEW) include at least Cry1Ab and Cry2, Cry1F and Cry2, Cry1Ab and Cry2/Vip3A stack, Cry1Ab and Cry1 FNip3A stack, as well as Cry1 F and Cry2/Vip3A stack. Combinations appropriate for use against fall armyworm (FAW), black cutworm (BCW), and/or western bean cutworm (WBCW) include Cry1Ab and Cry2/Vip3A stack, Cry1Ab and Cry1F/Vip3A stack, as well as Cry1F and Cry2/Vip3A stack. Also, these various combinations may be combined in order to provide resistance management to multiple pests. Other combinations include, but are not limited to, those described in the following applications: U.S. application Ser. No. 12/244,858; U.S. Pub. No. 2008/0226753; and PCT/U.S.07/88829.

The plants of the embodiments can also contain gene stacks containing a combination of genes to produce plants with a variety of desired trait combinations including, but not limited to, traits desirable for animal feed such as high oil genes (e.g., U.S. Pat. No. 6,232,529); balanced amino acids (e.g., hordothionins (U.S. Pat. Nos. 5,990,389; 5,885,801; 5,885,802; 5,703,049); barley high lysine (Williamson et al. (1987) Eur. J. Biochem. 165:99-106; WO 98/20122) and high methionine proteins (Pedersen et al. (1986) J. Biol. Chem. 261:6279; Kirihara et al. (1988) Gene 71:359; Musumura et al. (1989) Plant Mol. Biol. 12:123)); increased digestibility (e.g., modified storage proteins (U.S. Pat. No. 6,858,778) and thioredoxins (U.S. Pat. No. 7,009,087)).

The plants of the embodiments can also contain gene stacks that comprise genes resulting in traits desirable for disease resistance (e.g., fumonisin detoxification genes (U.S. Pat. No. 5,792,931); avirulence and disease resistance genes (Jones et al. (1994) Science 266:789; Martin et al. (1993) Science 262:1432; Mindrinos et al. (1994) Cell 78:1089). In further embodiments, the first and/or second pest resistant crop plant further contains a herbicide resistance gene that provides herbicide tolerance, for example, to glyphosate-N-(phosphonomethyl) glycine (including the isopropylamine salt form of such herbicide). Exemplary herbicide resistance genes include glyphosate N-acetyltransferase (GAT) and 5-enolpyruvylshikimate-3-phosphate synthase (EPSPS), including those disclosed in US Pat. Application Publication No. US20040082770, as well as WO02/36782 and WO03/092360). Herbicide resistance genes generally code for a modified target protein insensitive to the herbicide or for an enzyme that degrades or detoxifies the herbicide in the plant before it can act. See, e.g., DeBlock et al. (1987) EMBO J. 6:2513; DeBlock et al. (1989) Plant Physiol. 91:691; Fromm et al. (1990) BioTechnology 8:833; Gordon-Kamm et al. (1990) Plant Cell 2:603; and Frisch et al. (1995) Plant Mol. Biol. 27:405-9. For example, resistance to glyphosate or sulfonylurea herbicides has been obtained using genes coding for the mutant target enzymes, EPSPS and acetolactate synthase (ALS). Resistance to glufosinate ammonium, bromoxynil, and 2,4-dichlorophenoxyacetate (2,4-D) have been obtained by using bacterial genes encoding phosphinothricin acetyltransferase, a nitrilase, or a 2,4-dichlorophenoxyacetate monooxygenase, which detoxify the respective herbicides. Also contemplated are inhibitors of glutamine synthase such as phosphinothricin or basta (e.g., bar gene).

Other plants of the embodiments may contain stacks comprising traits desirable for processing or process products such as modified oils (e.g., fatty acid desaturase genes (U.S. Pat. Nos. 5,952,544; 6,372,965)); modified starches (e.g., ADPG pyrophosphorylases (AGPase), starch synthases (SS), starch branching enzymes (SBE), and starch debranching enzymes (SDBE)); and polymers or bioplastics (e.g., U.S. Pat. No. 5,602,321; beta-ketothiolase, polyhydroxybutyrate synthase, and acetoacetyl-CoA reductase (Schubert et al. (1988) J. Bacteriol. 170:5837-5847)). One could also combine the polynucleotides of the embodiments with polynucleotides providing agronomic traits such as male sterility (e.g., see U.S. Pat. No. 5,583,210), stalk strength, flowering time, or transformation technology traits such as cell cycle regulation or gene targeting (e.g., WO 99/61619; U.S. Pat. Nos. 6,518,487 and 6,187,994).

These stacked combinations can be created by any method including, but not limited to, cross-breeding plants by any conventional or TopCross methodology, or genetic transformation. If the sequences are stacked by genetically transforming the plants, the polynucleotide sequences of interest can be combined at any time and in any order. For example, a transgenic plant comprising one or more desired traits can be used as the target to introduce further traits by subsequent transformation. The traits can be introduced simultaneously in a co-transformation protocol with the polynucleotides of interest provided by any combination of transformation cassettes. For example, if two sequences will be introduced, the two sequences can be contained in separate transformation cassettes (trans) or contained on the same transformation cassette (cis). Expression of the sequences can be driven by the same promoter or by different promoters. In certain cases, it may be desirable to introduce a transformation cassette that will suppress the expression of the polynucleotide of interest. This may be combined with any combination of other suppression cassettes or overexpression cassettes to generate the desired combination of traits in the plant. It is further recognized that polynucleotide sequences can be stacked at a desired genomic location using a site-specific recombination system. See, e.g., WO 99/25821, WO 99/25854, WO 99/25840, WO 99/25855, and WO 99/25853.

In addition, pest resistance may be conferred via treatment of plant propagation material. Before plant propagation material (fruit, tuber, bulb, corm, grains, seed), but especially seed, is sold as a commercial product, it is may be treated with a protectant coating comprising fungicides, insecticides, herbicides, bactericides, nematicides, molluscicides, or mixtures of two or more of these preparations, if desired together with further carriers, surfactants, or application-promoting adjuvants customarily employed in the art of formulation to provide protection against damage caused by bacterial, fungal, or animal pests. In order to treat the seed, the protectant coating may be applied to the seeds either by impregnating the tubers or grains with a liquid formulation or by coating them with a combined wet or dry formulation. In addition, in special cases, other methods of application to plants are possible, e.g., treatment directed at the buds or the fruit.

Further, native resistance genes can also be used in the present invention, such as maysin (Waiss, et al., J. Econ. Entomol. 72:256-258 (1979)); maize cysteine proteases, such as MIR1-CP, (Pechan, T. et al., Plant Cell 12:1031-40 (2000)); DIMBOA (Klun, J. A. et al., J. Econ. Entomol. 60:1529-1533 (1967)); and genes for husk tightness (Rector, B. G. et al., J. Econ. Entomol. 95:1303-1307 (2002)). Such genes may be used in the context of the plants in which they are found, or inserted to other plants via transgenic means as is known in the art and/or discussed herein.

Methods for managing pest resistance to pest resistant crop plants are provided. One such method comprises manipulating, during the seed production process, the relative production of a first and second type of seed, the first type of seed incorporating a first transgene, which controls a first target pest via a first mode of action, and the second type of seed incorporating a second transgene, which controls the first target pest via a second mode of action, to produce about a predetermined ratio of the first and second seed types that, when planted in a plot in a substantially similar ratio, delays the development of resistant pests, and planting the first and second seed types in a plot in a substantially similar ratio. Alternatively, the first type of seed may incorporate a first and second transgene, which control a first target pest via first and second mode of action respectively, and a second type of seed, which does not have either the first or second transgenes (and therefore serves as a refuge for susceptible pests). The second type of seed may optionally have a third transgene that offers control of the second target pest. The seeds or resulting crops may be treated with an additional pesticidal agent, and may also incorporate herbicide resistance.

This manipulation may be done in any number of ways. For example, the levels of the two types of seed may be directly controlled during the seed processing and packaging process. This allows for fairly precise modulation of the amount of seed of the first and second types in each package of seed. Alternatively, the relative amounts of each type of seed may be manipulated during the seed production phase, such as, for example, by varying the number of certain parental plants in a hybrid seed production field. By introducing another alternative source of parental genetics into such a production field, a number of the resultant seeds produced will be of a second type as compared to those typically produced in the field. By varying the percent of the field comprising the alternative source of parental genetics, the relative amount of the second type of seed produced may be varied as well.

The methods of the invention can involve the packaging one or more types of seed into a package or packages. “Packaging” is intended to mean that the one or more types of seeds are put together in one place or combined in the case of two or more types of seed. A “package” is not limited to any particular type of bag, box, or other container but includes any object capable of holding the one or more types of seeds after packaging, including, for example, any surface which can accommodate the one or more types of seeds. A “package” of the present invention may be capable of being closed or sealed. However, the present invention does not depend on the use of a package that that is capable of being closed or sealed.

Another such method comprises determining, in a batch of a first type of seed, the first type of seed pesticidal to a first pest via a first mode of action, the level of seeds not of the first type, assessing whether the level of seeds not of the first type will satisfy requirements for delaying development of resistant pests, and if the level of seeds not of the first type is sufficient, planting the first type of seed and the seeds not of the first type in a plot. Alternatively, the first type of seed may incorporate a first and second transgene, which control a first target pest via first and second mode of action respectively, and a second type of seed, which does not have either the first or second transgenes (and therefore serves as a refuge for susceptible pests). The second type of seed may optionally have a third transgene that offers control of the second target pest. If the level of seeds not of the first type will not satisfy requirements for delaying development of resistant pests, the level of seed not of the first type may be altered until the requirements are met, and planting of the first type of seed and the seeds not of the first type may then be completed. The seeds or crops may be treated with an additional pesticidal agent, and may also incorporate herbicide resistance.

These methods avoid the development of resistance in a target pest by ensuring one of at least two alternative situations exists. For example, when the first and second type of seeds are for pest resistant crops, but through different modes of pesticidal action, rare pests that posses a resistance gene to the first type of seed will only in extremely rare circumstances also posses a resistance gene to the second type of seed. As a result, pests exhibiting resistance to the first or the second type of seed (but not both) are either killed by also feeding on the other type of plant, or mate with individuals lacking such resistance or that, at worst, possess the alternative resistance. The result is individuals that are heterozygotic for, at worst, resistance to both types of seed, but heterozygotes are generally killed by high-dose strategies as discussed above. As a result, the increased prevalence of resistant pests is slowed.

Alternatively, when the seeds are of a first type that is pesticidal to a target pest via first and second modes of pesticidal action are mixed with “impurities,” namely seeds not of the first type, a similar situation arises. In such situations, if the approximate level of impurities is sufficient to satisfy whatever refuge is required (for example, by a regulatory agency), or prudent. This is accomplished because those impurities provide the necessary refuge.

The source of seeds not of the first type may be intentional production variation, such as, for example, by planting a certain number of a plants with differing genetics in a hybrid seed production plot, or it could be based on random error, as is always present in such plots, whether due to selfing, pollen drift, or other factors. The “impurities” (seeds not of the first type) may even be introduced intentionally during the manufacturing process, such as by inserting a number of impurity seeds into a bag of seeds of the first type.

While the method works more favorably when the refuge required for regulatory purposes is low for the insect control mechanism, it may be used in situations where a substantial refuge is still required. By way of non-limiting example, in corn, pests in the orders Lepidoptera and Coleoptera are often of interest, particularly pests such as CRW and ECB, as well as others previously described. Also as noted previously, it is advantageous for farmers to have as much of a crop as possible resistant to pests prevalent in a given area in order to maximize yield. Additionally, the same methods may be employed for multiple pests in the same plot. As multiple insect control mechanisms may be used in connection with a single type of seed, it is therefore possible for the disclosed methods to eliminate the compliance issues with regard to multiple target pests by incorporating the necessary refuge for both types of seed or both modes of pesticidal action, either via manipulation during the production process or by assessing the level of impurities as described previously.

While the invention is described predominantly using examples of pests affecting corn, the invention herein may also be applied to fields where resistance management is needed in the context of other crops, including soybeans, wheat, barley, sorghum, cotton, rice and the like.

In some embodiments, one or both of the sources of insect control is a pesticidal or insecticidal agent. In such embodiments, the provider of the pesticide or insecticide will cycle which pesticide(s) or insecticide(s) are available for use by growers in a given growing season. This may be done in conjunction with the availability of seeds of pest resistant plants. A “pesticidal agent” is a pesticide that is supplied externally to the crop plant, or a seed of the crop plant. The term “insecticidal agent” has the same meaning as pesticidal agent, except its use is intended for those instances wherein the pest is an insect. Pesticides suitable for use in the invention include pyrethrins and synthetic pyrethroids; oxadiazine derivatives (see, e.g., U.S. Pat. No. 5,852,012); chloronicotinyls (see, e.g., U.S. Pat. No. 5,952,358); nitroguanidine derivatives (see, e.g., U.S. Pat. Nos. 5,633,375; 5,034,404 and 5,245,040.); triazoles; organophosphates; pyrrols, pyrazoles and phenyl pyrazoles (see, e.g., U.S. Pat. No. 5,952,358); diacylhydrazines; carbamates, and biological/fermentation products. Known pesticides within these categories are listed in, for example, The Pesticide Manual, 11 th ed., (1997) ed. C. D. S. Tomlin (British Crop Protection Council, Farnham, Surrey, UK). When an insecticide is described herein, it is to be understood that the description is intended to include salt forms of the insecticide as well as any isomeric and/or tautomeric form of the insecticide that exhibits the same insecticidal activity as the form of the insecticide that is described. The insecticides that are useful in the present method can be of any grade or purity that passes in the trade as such insecticide. In still other embodiments, the first and/or second pest resistant crop plant is optionally treated with acaricides, nematicides, fungicides, bactericides, herbicides, and combinations thereof.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

That which is claimed:

1. A method of reducing the development of resistant pests comprising:
(a) manipulating production of seed in order to have appropriate amounts of one or more seed types in a given production source to meet insect resistance management requirements, wherein at least one of the one or more seed types is pesticidal to a first target pest through a first mode of pesticidal action, and
(b) planting the one or more seed types in a first plot.

2. The method of claim 1, wherein the manipulating production of seed comprises planting a ratio of a plurality of parental lines in a seed production field, wherein the ratio is about the same as the resistance management requirement for the one or more seed types.

3. The method of claim 1, wherein the manipulating production of seed comprises packaging the appropriate amounts of one or more seed types into one or more packages during the packaging process.

4. The method of claim 2, wherein the manipulating production of seed comprises planting seeds from one or more of the packages in the plot.

5. The method of claim 1, wherein the first target pest is selected from the group consisting of Western Corn Rootworm, Northern Corn Rootworm, Mexican Corn Rootworm, and Southern Corn Rootworm.

6. The method of claim 5, wherein the first target pest is Western Corn Rootworm.

7. The method of claim 1, wherein the first target pest is selected from the group consisting of European corn borer, corn earworm, and southwestern corn borer.

8. The method of claim 7, wherein the first target pest is European corn borer.

9. The method of claim 1, further comprising treating at least one of the one or more seed types with a pesticidal agent.

10. The method of claim 9, wherein said pesticidal agent is selected from the group consisting of an insecticide, an acaricide, a nematicide, a fungicide, a bactericide, a herbicide, or a combination thereof.

11. The method of claim 1, wherein at least one of the one or more seed types incorporates a herbicide resistance gene.

12. A method of reducing the development of resistant pests comprising:
(a) determining the level of impurities present in a set of seeds, the set of seeds comprising a first type of seeds and seeds not of the first type, the first type of seeds pesticidal to a first target pest via a first mode of pesticidal action,
(b) comparing the level of seeds not of the first type in the set of seeds to the level of seeds not of the first type sufficient to slow development of resistant pests, and
(c) if necessary, adjusting the level of seeds not of the first type so that the level of seeds not of the first type is at least about the level of seeds not of the first type sufficient to slow development of resistant pests.

13. The method of claim 12, wherein the level of impurities is determined as a percentage of seeds not of the first type in the set of seeds.

14. The method of claim 12, wherein the first type of seeds is also pesticidal to the first target pest via a second mode of pesticidal action.

15. The method of claim 12, wherein adjusting the level of seeds not of the first type comprises adding seeds not of the first type to the set of seeds.

16. The method of claim 12, wherein adjusting the level of seeds not of the first type comprises removing seeds of the first type from the set of seeds.

17. The method of claim 12, wherein the first target pest is selected from the group consisting of Western Corn Rootworm, Northern Corn Rootworm, Mexican Corn Rootworm, and Southern Corn Rootworm.

18. The method of claim 17, wherein the first target pest is Western Corn Rootworm.

19. The method of claim 12, wherein the first target pest is selected from the group consisting of European corn borer, corn earworm, and southwestern corn borer.

20. The method of claim 19, wherein the first target pest is European corn borer.

21. The method of claim 12, further comprising treating the set of seeds with a pesticidal agent.

22. The method of claim 21, wherein said pesticidal agent is selected from the group consisting of an insecticide, an acaricide, a nematicide, a fungicide, a bactericide, a herbicide, or a combination thereof.

23. The method of claim 12, wherein the first type of seeds incorporates a herbicide resistance gene.
